(19) United States
(12) Patent Application Publication
(10) Pub. No.: US 2026/0111026 A1
(43) Pub. Date: Apr. 23, 2026

(54) SYSTEM FOR CONTROLLING A TRANSITION BETWEEN A FIRST AREA AND A SECOND AREA IN AN OPERATING ENVIRONMENT

(71) Applicants: Jungheinrich Aktiengesellschaft, Hamburg (DE); Jungheinrich Systemlösungen GmbH, Graz (AT)

(72) Inventors: Paul Hohmann, Moosburg (DE); Christian Engert, Kirchheim (DE); Dominik Wiesner, Graz (AT)

(73) Assignees: Jungheinrich Aktiengesellschaft, Hamburg (DE); Jungheinrich Systemlösungen GmbH, Graz (AT)

(21) Appl. No.: 19/363,073

(22) Filed: Oct. 20, 2025

(30) Foreign Application Priority Data
Oct. 21, 2024 (EP) 24207805.3

(51) Int. Cl. G05D 1/229; G05D 1/242

(52) U.S. Cl. CPC G05D 1/2297; G05D 1/2427

(57) ABSTRACT

Disclosed is a system for controlling a transition between a first area and a second area in an operating environment. The system includes a transition area separating the first area from the second area of the operating environment, a monitoring device with at least two opposing first sensor units and adapted to span in the transition area a substantially horizontally oriented monitoring field, at least one pair of entry fields extending in a depth direction from the monitoring, and a control unit adapted to communicate with vehicles moving in the operating environment.

### CROSS REFERENCE TO RELATED APPLICATION

This application claims priority to European Patent Application No. 24207805.3, filed in Germany on Oct. 21, 2024, the entire contents of which are hereby incorporated herein by this reference.

### DESCRIPTION

The present invention relates to a system for controlling a transition between a first area and a second area in an operating environment, a logistics facility comprising such a system for controlling a transition between a first area and a second area, and a method for controlling a transition between a first area and a second area of an operating environment.

In operating environments, such as logistics facilities, it is known to divide areas that can be accessed by vehicles, for example with regard to different safety levels. Among other things, it is possible to divide the area into freely accessible areas, in which mixed traffic is permitted and therefore people are also allowed to be present, and an automated area, in which only automated vehicles and devices may be operated. Automated or autonomous vehicles are also operated in the freely accessible area, but they must be equipped with sensors and a corresponding data processing unit in order to be operated safely even when encountering people and manually driven vehicles. These safe automatic or automated vehicles and additionally non-safe automated vehicles may also be operated in the automated area, to which, however, manually driven vehicles and persons in operation are prohibited from access. The non-safe automated vehicles do not have the appropriate sensor technology and data processing to be operated safely even when encountering manually driven vehicles and, in particular, people.

If a human operator wishes to enter such an automated area, for example to carry out maintenance or similar, a suitable safety door must be installed to ensure that the corresponding vehicles and devices located in this automated area remain stationary during the person's stay in order to prevent accidents. As a rule, the operation of the non-safe automated vehicles in the automated area is interrupted by actuating and triggering corresponding sensors, such as safety switches or similar, when the safety door is passed through. This is due to the fact that in the automated area, even in normal operation, lower safety standards can be maintained with regard to the operation of vehicles and devices due to the assumed absence of human persons, as interactions and accidents with human persons should be excluded from the outset due to the mode of operation of the automated area.

On the other hand, however, in certain operating sequences there is a need to allow a vehicle access to such a security area, such as the automated area of a logistics facility mentioned above, in particular in order to transport goods into this security area. For this purpose, it is necessary to provide a system for controlling access to the security area, or more generally, for controlling a transition between a first area and a second area in the corresponding operating environment. On the one hand, this enables safe vehicles in normal and intended operation to drive from a freely accessible area of the operating environment, such as the aforementioned area with mixed traffic, into the safety area and vice versa, while on the other hand the system does not allow human persons or unauthorized vehicles to enter or drive into the safety area.

At the same time, it is desirable to enable authorized vehicles to pass through such a system as easily and efficiently as possible, as the use of locks with several doors or the like, for example, requires a delay or even a stop of the corresponding vehicles, which is to be regarded as disadvantageous against the background of the smoothest possible operation. The authorized vehicles are usually safe automatic or automated vehicles, such as driverless transport systems or underride shuttles.

Accordingly, it is the task of the present invention to provide a system for controlling a transition between a first area and a second area in an operating environment, which on the one hand allows efficient transitions between the two areas, but reliably prevents corresponding transitions by human operators or non-authorized vehicles, or in such a case detects an impermissible operating state, on the basis of which appropriate measures can then be taken.

For this purpose, the system according to the invention comprises a transition region which separates the first region from the second region of the operating environment and which is bounded on both sides in a width direction, a monitoring device which comprises at least two first sensor units which are opposite one another with respect to the transition region and is set up for this purpose, in the transition region, a substantially horizontally aligned monitoring field with a predetermined extension in a depth direction, which extends over the entire width of the transition region, and at least one pair of entry fields which extend in the depth direction with respect to the monitoring field and each have a predetermined extension in the width direction and the depth direction, and a control unit which is operatively coupled to the monitoring device, operatively coupled to the monitoring device and further adapted to communicate with vehicles traveling in the operational environment, wherein the control unit being further adapted to receive requests from the vehicles to pass through the transition area and, on receipt of such a request, to perform the steps of monitoring one of the pairs of entry fields for a substantially simultaneous violation by a vehicle, on detection of such a simultaneous violation of the corresponding pair of entry fields, releasing a passage corridor through the monitoring field, the passage corridor having a predetermined width and lying in extension of the pair of entry fields, and monitoring the passage of the vehicle through the passage corridor, and on detection of a completion of the passage, deactivating the passage corridor.

It should first be noted that the lateral boundary of the transition area can be achieved, for example, by a structural boundary, in particular by the transition area being formed in the area of a simple structural passage between the first area and the second area, for example a recess in a fence or a wall, so that the structural boundary is defined both in the height and width direction by the corresponding recess. Alternatively, however, the lateral and possibly also an upper boundary of the monitoring area could also be achieved by further suitable sensor devices in these areas, in particular so-called light fences, which monitor the boundary area, whereby suitable measures can be initiated when this area is entered, for example analogous to a violation of the monitoring field in the transition area.

In the first-mentioned example of a structural boundary, the monitoring field can accordingly extend in a substantially horizontal plane in the area of this structural separation in the depth direction between the first area and the second area, i.e. in a plane perpendicular to the plane defined by the corresponding passage. Ultimately, however, this lateral and possibly upper boundary of the transition area is only relevant in that it prevents the transition area from being bypassed and, accordingly, transitions between the first area and the second area can only take place at positions which are in fact monitored by the system according to the invention.

It should also be noted that the extension of the entry fields in the depth direction in relation to the monitoring field is to be understood in such a way that they can either be directly adjacent to the monitoring field or a certain distance can be provided between them without this having any effect on the intended functionality of the entry fields.

It should also be noted that the monitoring device referred to and the control unit can be integrated with one another in various ways, for example by means of two independent components which are operationally coupled with one another, or in another case the control unit can also already be at least partially entrusted with the evaluation of the data supplied by the at least two sensor units, so that it takes over part of the functionality of the monitoring device itself.

Furthermore, it should be noted that the deactivation of the drive-through corridor referred to must be adjusted after a vehicle has completed driving through it in such a way that the release for driving through this corridor is canceled or terminated, so that between the deactivation of the drive-through corridor referred to and a new possible passage through the transition area, a new request for driving through it must be received by the control unit.

Furthermore, it should be noted at this point that in the system according to the invention, passing through the passage corridor after a previous request for passage is the only permitted or permissible option for passing through the transition area and all other interventions in a monitoring field are always registered and evaluated as an impermissible violation thereof. This includes, among other things, a violation of the monitoring field in a state in which the control unit has not yet received a request to drive through the transition area and accordingly no passage corridor has yet been released, or, for example, a state in which the passage corridor is at least partially left, i.e., for example, a vehicle or a person in a state of a released passage corridor violates the monitoring field outside of this corridor.

With regard to the entry fields to be considered, it should also be noted that for vehicles that can send a corresponding request to the control unit to drive through the transition area, the positions or intended routes of these vehicles are known and, accordingly, entry fields can always be activated and monitored at suitable positions and, in particular, on the sides of the monitoring field. It should already be pointed out at this point that further vehicle-specific information can be transmitted as part of the requests from vehicles, for example time stamps, vehicle types or identifiers of certain vehicles, positions and/or planned routes, or even a load status of a corresponding vehicle, whereby the way in which such additional information can be used by the control unit to increase the safety of the system will be discussed in more detail below.

In any case, however, it is clear that the way in which the system according to the invention is designed and, in particular, the monitoring of the entry fields for the receipt of a request to pass through the transition area and the subsequent activation of a spatially restricted passage corridor for a vehicle are all measures that prevent an unauthorized person or an unregistered vehicle from passing through the transition area.

In this context, it should be noted that the control unit can also instruct the activation of a pair of entry fields only after a request to pass through the transition area has been received, i.e. in a state in which no such request has been received, only the horizontal monitoring field would be spanned, since in such an operating state it is not possible to pass through the transition area in any way anyway. Alternatively, however, it would also be conceivable that corresponding entry fields would be permanently monitored, but entry would not be permitted without prior request, so that in this state they would essentially represent an extension of the monitored field.

In order to further increase the safety of the system according to the invention, the

control unit can also be set up to divide the passage corridor into a first passage section and a second passage section with respect to an intended passage direction from the entry fields and to monitor that the first passage section is entered first and then the second passage section, and/or a further pair of entry fields can lie opposite each pair of entry fields in relation to the horizontal monitoring field, and the control unit can furthermore be set up to determine a direction of passage of a corresponding vehicle by means of the monitoring of the entry fields and the horizontal monitoring field. Accordingly, these additional measures verify the respective directions of travel of corresponding vehicles and can, for example, rule out cases in which a person could attempt to pass through a transit corridor against the intended direction of travel of a vehicle. Furthermore, in the embodiment just described, it can be ensured that no person behind a vehicle passes through a corresponding corridor, since in such a case, after a determined entry into the second passage section and a corresponding subsequent exit from the first passage section, a re-entry into the second passage section by the person would be registered, which would be evaluated by the system as an impermissible process.

A further measure for increasing the operational reliability of the system according to the invention can be that the control unit can also be set up to start timing after receiving a request for a passage through the transition area and to deactivate the entry fields and/or the passage corridor after a predetermined maximum period of time and/or to monitor that a passage through the passage corridor requires at least a predetermined minimum period of time. Accordingly, it can also be ensured in this way that an intended operation of corresponding vehicles in interaction with the system according to the invention is maintained by ensuring that corresponding vehicles move through the transition area in the expected manner by appropriately selecting the maximum and/or minimum time spans. If, for example, it is determined that a predetermined maximum period of time has elapsed after a request has been received before a pair of entry fields are entered in the intended manner, either the state of the system could simply be reset and a new request waited for, but it would also be possible to issue a warning to a human operator or at least shut down parts of the system, as an intended operating sequence could obviously not be carried out in the desired manner. In the same way, it is also possible to determine whether the passage corridor or the first and second passage sections are occupied for too long or too short a time and thus determine an undesirable operating sequence because the object that has entered is longer/shorter than registered or is traveling faster or slower than registered.

In order to further increase the operating efficiency of the system according to the invention and, for example, to permit simultaneous traffic moving in opposite directions through the transition area from the first area into the second area and from the second area into the first area, the control unit can also be set up to be able to release at least two passage corridors spaced apart in the width direction with entry fields assigned to them. Corridors can only be enabled from the outset for passage in opposite directions, but constellations are also conceivable in which two corridors could be enabled simultaneously in the same direction to enable parallel passage in the same direction.

In particular in such embodiments of a system according to the invention, in which more than one passageway corridor can be enabled at the same time, the monitoring device can also comprise at least one further sensor unit, which is arranged above the horizontal monitoring field, for example on an upper side of a structurally limited passageway in the transition area. This can eliminate shadowing which is present on the respective rear sides of the corresponding vehicles passing through the transition area for the first sensor units already mentioned in the area of their monitoring level, in particular between two vehicles when they pass through the system at the same time.

Furthermore, it is possible for the monitoring device to be set up to use the at least one further sensor unit to set up a further, essentially vertical monitoring field, whereby the height of the at least one passage corridor can be limited by means of the vertical monitoring field and/or the monitoring device is also set up to set up a narrow field within the at least one passage corridor, in particular by means of a horizontally aligned, very narrow monitoring field in the direction of travel or a light barrier running transverse to the direction of travel. This additional vertical monitoring field can completely or partially cover a corresponding structural boundary of the transition area, so that, for example, individual height sections can be monitored by means of a suitable design of such a field or a complete cover can be formed in the corresponding area. In any case, such a vertical limitation of the drive-through corridor represents a further safety mechanism, since in this way, for example, cases can be ruled out in which a person attempts to ride along on a vehicle regularly driving through the monitored area. The vertical monitoring field and/or the narrow field can also be used to ensure that two objects do not cross a corresponding passage corridor at a short distance behind each other, for example a person just in front of or behind a vehicle. The very narrow fields referred to here can, for example, be spanned by the sensor units of the monitoring unit itself or additional sensor units and typically have widths in the range of millimeters or a few centimeters, so that they can essentially simulate the effect of a light barrier.

It should further be noted that the control unit may further be adapted to determine or adjust the minimum time period and/or the maximum time period and/or the height and/or width of the drive-through corridor based on at least one characteristic of the corresponding vehicle, which has been received in the form of vehicle-specific information in connection with the request for a drive-through. As already indicated above, corresponding vehicle-specific information can include the vehicle type or a vehicle identifier, a load status and similar, whereby it can be assumed, for example, that the driving speed of a heavily loaded vehicle may be reduced and accordingly a maximum time period for driving through the passage corridor would have to be adjusted or the height of the passage corridor would have to be increased due to the load carried. Furthermore, the height of the passage corridor and/or its width can be determined from the outset on the basis of the vehicle type in order to enable an even more precise determination of the dimensions thereof for a specific vehicle and thus further increase the security of the system according to the invention with regard to unauthorized access.

In addition, the control unit can also be set up to accept a request to drive through the transition area only if a current distance of the corresponding vehicle from the horizontal monitoring field is below a predetermined maximum distance, which can preferably be 180 mm or less. This can also rule out cases in which, for example, a person could try to move through a corresponding passage corridor in front of a vehicle that is registered regularly. The data required for this purpose regarding the distance or position of the corresponding vehicle relative to the monitoring field can, among other things, be sent by the vehicle together with the request to drive through the transition area, provided that this has a sufficiently precise self-localization function, or a separate sensor system can be provided, which is coupled to the control unit of the system and is able to determine a distance or position of a vehicle relative to the horizontal monitoring field.

As already briefly indicated above, the control unit can also be set up to instruct the triggering of at least one predetermined safety measure, in particular the immobilization of devices and/or vehicles in the operating environment, in the event of unauthorized entry into the transition area, whereby any process in which one of the monitoring fields outside an enabled passage corridor is entered or violated is to be assessed as unauthorized entry into the transition area.

According to a further aspect, the present invention relates to a logistics device comprising an operating environment having a first area and a second area and a transition area disposed between the first area and the second area, wherein a system according to the invention for controlling a transition between the first area and the second area is further provided. Here, one of the first area and the second area can serve as a safety area in the manner already outlined above, whereby devices located in the safety area can be shut down in particular in the event of unauthorized entry into the transition area.

Furthermore, the present invention relates to a method for controlling a transition between a first area and a second area of an operating environment, in particular a logistics facility, by means of a system of the type described above, comprising a permanent monitoring of the horizontal and optionally the vertical monitoring field, and, on receiving a request for a passage through the transition area from a vehicle moving in the operating environment, a monitoring of at least one pair of entry fields with regard to a substantially simultaneous violation by a vehicle, when such a substantially simultaneous violation of the corresponding pair of entry fields is detected, releasing a passage corridor through the monitoring field, the passage corridor having a predetermined width and possibly a predetermined height and lying in extension of the pair of entry fields, and monitoring a passage of the vehicle through the passage corridor and, when a completion of the passage is detected, deactivating the passage corridor.

It is understood here that the additional features discussed above in connection with the description of further developments and embodiments of the system according to the invention are also readily transferable to a method according to the invention and can be used together with it, for example the possible release of at least two passage corridors spaced apart in the width direction and/or the triggering of at least one predetermined safety measure in the event of unauthorized entry into the transition area. Accordingly, all features claimed as further embodiments of a system according to the invention in the appended claims should also be claimed in connection with a method according to the invention. It should merely be emphasized again in particular that the method according to the invention can comprise, in connection with receiving the request for passing through the transition area, receiving further vehicle-specific information, in particular a vehicle type and/or a vehicle identifier, and/or adapting the minimum time period and/or the maximum time period and/or the height and/or width of the passage corridor on the basis of the vehicle-specific information.

### BRIEF DESCRIPTION OF THE DRAWINGS

Further features and advantages of the present invention will become even clearer from the following description of an embodiment thereof, when considered together with the accompanying figures. Figures:

FIG. 1: a schematic isometric view of a system according to the invention for controlling a transition between a first area and a second area in an operating environment;

FIGS. 2a to 2f: schematic representations of the system from FIG. 1 during a drive-through by one or two vehicles in schematic top view; and

FIG. 3: a flow chart illustrating the processes shown in FIGS. 2a to 2f.

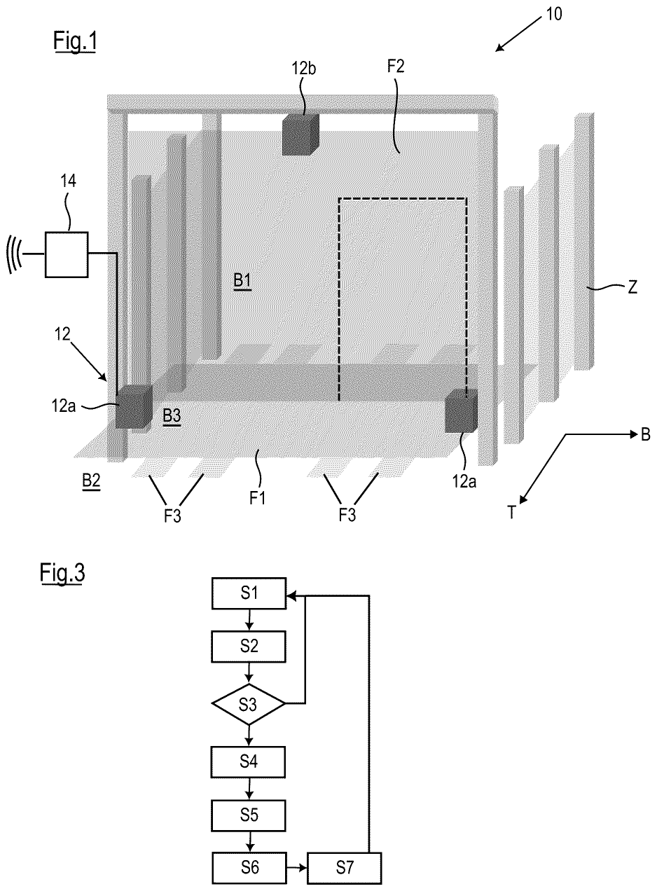

In FIG. 1, a system according to the invention for controlling a transition between a first area and a second area in an operating environment, for example in a logistics facility, is now shown in a schematic isometric view and generally designated by the reference sign 10. Furthermore, the first area bounded by a fence Z acting as a structural separation and acting as a safety area in the present example is designated B1 and a freely accessible area is designated B2, a transition area B3 being provided between these areas, which is monitored by the system 10 according to the invention. Here, the system 10 generates the monitoring fields described in more detail below and accordingly monitors whether transitions between the first area B1 and the second area B2 are carried out through the transition area B3 in a permissible manner.

It should also be noted that the actual transition between areas B1 and B2 is provided in the form of a passageway in the fence Z, which is closed on both sides and at the top, whereby a monitoring device 12 with two first sensor units 12a in the form of 2D lidar sensors is provided in the area of this passageway, which are located opposite each other on both sides of area B3.

Furthermore, in addition to data processing means not shown here, the monitoring device 12 also comprises a further sensor unit 12b, which is positioned centrally above the transition area B3. Accordingly, the monitoring device 12 spans, in the manner indicated in FIG. 1, by means of the sensor units 12a and 12b, a substantially horizontally oriented monitoring field F1 with a predetermined extent in a depth direction T, which extends over the entire width of the transition region B3, as well as a further, substantially vertical monitoring field F2, which in the embodiment shown here covers the entire passage between the first region B1 and the second region B2 in the manner of a curtain.

Furthermore, it should be noted that the first sensor units 12a are also used to define several pairs of entry fields F3, which extend in the depth direction T from the horizontal monitoring field F1 and each have a predetermined extent in the width direction B and the depth direction T. It should be noted here that the corresponding pairs of entry fields F3 each have a distance, the corresponding dimensions of which are matched to the dimensions of vehicles located in the operating environment, in order to ensure that in the process described below only corresponding vehicles can pass through the transition area in an authorized manner and not, for example, human persons.

With regard to the arrangement of the sensor units 12a and 12b, it should be noted that the first sensor units 12a are arranged in the height range in which they span the horizontal monitoring field, whereby shading on the opposite side is to be expected when a vehicle passes through. In order to enable simultaneous passage of two vehicles corresponding to the right and left pairs of entry fields F3 shown in FIG. 1, the additional sensor unit 12b is used on the upper side of the passage, which also spans the essentially vertical monitoring field F2 already mentioned.

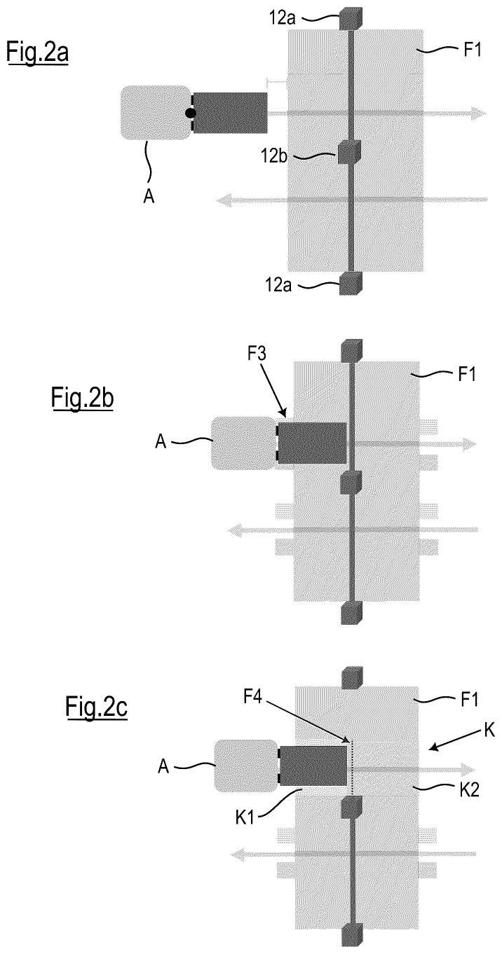

Furthermore, the system 10 according to the invention comprises a control unit 14, shown here only schematically, which on the one hand is operationally coupled to the monitoring device 12 and is also set up for wireless communication with vehicles moving in the operating environment, one or two of which are shown in FIGS. 2a to 2f. It should be noted here that in the state shown in FIG. 1, any violation of one of the monitoring fields F1 and F2 would be immediately registered as an unauthorized entry or unauthorized transition between the first area B1 and the second area B2 and corresponding measures could be initiated by the control unit 14, for example the shutdown of certain components in the operating environment. Communication between the control unit 14 and the vehicles can also take place by means of a central control unit of the logistics system, which is in communication with the vehicles and to which the control unit 14 is connected by wire or wirelessly.

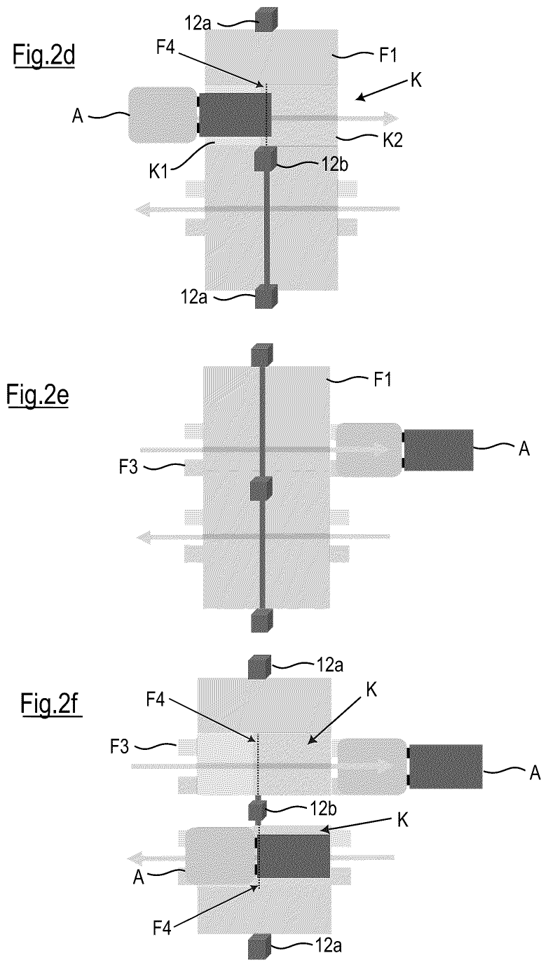

FIGS. 2a to 2e in conjunction with the flow diagram in FIG. 3 should now be used to explain how a permissible passage through the transition area B3 can take place. For this purpose, in step S1 of FIG. 3 and analogously in FIG. 2a, a vehicle A first sends a request to the control unit 14 to drive through the transition area B3, whereby in this context further data is transmitted by the vehicle A, for example a type identifier, a vehicle type, whether the vehicle is currently carrying a load or not and, if applicable, what dimensions it has and similar. It is also determined whether the vehicle A is within a predetermined maximum distance from the horizontal monitoring field F1, for example 180 mm, which is indicated in FIG. 2a. This determination can be carried out using position data transmitted by the vehicle or by means of detection of the vehicle position by another sensor unit or the sensor units 12a already mentioned, as indicated in FIG. 2a.

If such a request is accepted by the control unit 14 as valid, since the corresponding vehicle A is to be allowed to pass and is located at a suitable position, the entry fields F3 already mentioned are activated in step S2, whereby either only a single such pair of entry fields F3 can be switched or also several of those shown in FIG. 1. In this context, the activation of the entry fields F3 can also mean that the vehicle only continues the drive-through process as intended when a corresponding request is made, as explained above.

Hereafter, in step S3, the control unit 14 monitors that the two entry fields F3 of the corresponding pair are violated or entered almost simultaneously, whereby a suitably selected very short period of time can be chosen for the first violation of each pair of entry fields. This ensures that the object violating the pair of entry fields is in fact the registered vehicle A, as this is located within the predetermined distance, for example 180 mm, from the monitoring field F1. If this is not the case, the process ends here and returns to step S1 or already detects unauthorized access to a monitoring field.

If, on the other hand, the control unit 14 determines in step S3 that the corresponding entry fields F3 are in fact violated almost simultaneously in the manner shown in FIG. 2b, a passage corridor K through the monitoring field is enabled in step S4, which is shown in FIG. 2c and, with regard to the horizontal monitoring field F1, is formed by two passage sections K1 and K2 arranged one behind the other, while it has a predetermined height with regard to the vertical monitoring field F2, which is already indicated by a dashed line in FIG. 1. At the same time, timing is started in order to monitor that a corresponding passage of the monitoring area B3 is carried out within a predetermined period of time.

The vehicle A then enters the drive-through corridor K and accordingly first enters the first drive-through section K1 and then the second drive-through section K2, as shown in FIG. 2d. After leaving the first passage section K1, a renewed violation of K1 would be an unauthorized event, on the basis of which appropriate measures could be initiated, for example a shutdown of the operating environment.

The corresponding sequential violation of these passage sections is monitored by the control unit 14 in step S5, whereby the state shown in FIG. 2e is assumed after the vehicle has passed through, in which the vehicle A has passed through the passage corridor K and consequently none of the monitoring fields are violated. This end of the passage of vehicle A through the passage corridor is recorded in step S6 and represents the end of the permitted passage through the transition area B3.

At this point, it is now explained how the system 10 according to the invention described here can prevent people from crossing the transition area B3 without authorization with the aid of the vertical monitoring field F2. Although even in the corresponding embodiment without such a vertical monitoring field F2, numerous scenarios in which unauthorized crossings of the transition area B3 are undertaken can already be prevented, the two horizontally extended passage sections K1 and K2, which are located one behind the other in the direction of travel, alone cannot detect when a person is moving in front of or behind a vehicle, since the passage sections K1 and K2 only detect a violation of this as such, but not where the violation takes place within the passage sections K1 and K2.

For example, a vehicle could move from a first passage section K1 towards a second passage section K2 and there could be a person behind the vehicle. The vehicle would first violate passage section K1 in the direction of travel and then violate passage section K2 in the course of the journey and then leave passage section K1. The person behind the vehicle would ensure that the passage section K1 would be violated for longer than would actually be expected due to the location of the vehicle. However, the system 10 would only recognize this longer violation of the passage section K1 as impermissible if the violation lasted for an impermissible period of time, which can easily be avoided if the person moves at a short distance from the vehicle. The person would cross from passage section K1 to passage section K2 behind the vehicle and finally leave the transition area B3 behind the vehicle from passage section K2 without being recognized.

In order to detect a person located behind or in front of the vehicle, it is necessary that, in addition to the extended passage sections K1 and K2, a very narrow field in the direction of travel in the form of the vertical monitoring field F2 or, in alternative variants, for example also by means of a horizontally aligned and very narrow monitoring field in the direction of travel or a light barrier, is set up so that this field F2 or the light barrier is not violated for a short time when there is a small distance between the vehicle and the person and is then subsequently violated again by the second object, i.e. the vehicle or the person, depending on which is located in front or behind,. i.e. the vehicle or the person, depending on which is in front or behind. Such an additional very narrow monitoring field is shown dotted in FIGS. 2c, 2d and 2f for reasons of clarity and is designated by the reference sign F4, whereby in the embodiment shown here it only extends in the area of the passage corridor K. In this way, it can be recognized that two separate objects are currently moving through the transition area B3. In variants with the vertical monitoring field, it should be noted that the safety function of the system 10 could be more easily circumvented with such an extended vertical field, for example by a person with an outstretched arm above the vehicle preventing the temporary interruption of the violation of the vertical monitoring field F2 and thus preventing the detection that two separate objects are involved. Preferably, very narrow fields, for example in the form of very narrow protective fields or light barriers, can be set up at the level of the horizontal fields or at least in the lower half of the system in the direction of travel and vertical direction, which are suitable for detecting a brief non-injury between two moving objects moving one behind the other through the transition area B3.

Accordingly, the following scenarios can be intercepted by the system 10 according to the invention in conjunction with conventional sensor units of corresponding vehicles. If, in the first case, a person were to walk in front of the vehicle, the vehicle's sensor system would already stop the vehicle for safety reasons and it would not be possible to activate the pair of entry fields F3 at the same time. This would cause the person to trigger an error and stop the vehicle. If, in a second case, a person were to walk behind the vehicle, an error and therefore a stop would be triggered as soon as the vertical monitoring field F2 or the very narrow monitoring field F4 or the light barrier is unobstructed once and is broken through again. Even if the person were to place a hand on the vehicle, at least in the case of the light barrier, it is first released and then broken through again. This would also trigger an error and thus a stop. In a third conceivable case, a person could sit on a pallet, but information about any load carried by the vehicle, for example including a load height, can also be communicated together with the request by the vehicle. On this basis, the height of the vertical monitoring field F2 can be set and a person sitting on the vehicle or load would exceed the specified contour accordingly and also trigger an error. Furthermore, if a person is next to the vehicle, the height and/or width of the passage corridor would be exceeded by the person, so that a fault would also be triggered in this case.

In any case, the method according to the invention ends at this point in step S7, in which the monitoring fields are switched back to their initial state as shown in FIG. 1. It should also be noted that both the time periods for safe passage through the transition area B3 and, for example, the height of the passage corridor, which is shown as a dashed line in FIG. 1, can be adjusted using the vehicle-specific data transmitted by the vehicle A to the control unit 14.

It should also be noted that any violation of one of the monitoring fields F1 and F2 outside the passage corridor K is always evaluated as an impermissible attempt to pass through the transition area B3 and suitable measures can be taken by the control unit 14 in response to this, such as shutting down individual components in the operating environment.

Finally, please refer to FIG. 2f, which shows a process in which two vehicles A cross the transition area B3 simultaneously in opposite directions. Here, each of the two vehicles A has undergone a process of a request to the control unit 14 to drive through the transition area B3, whereby the two parallel passage corridors K, which are then enabled, are each monitored in the same way as part of the process described above. Due to the respective shadowing behind the vehicles A from the viewpoint of the sensor units 12a, the additional sensor unit 12b not only fulfills the task of spanning the vertical monitoring field F2, but also of monitoring the central area of the horizontal monitoring field F1 between the two drive-through corridors K.

1. A system for controlling a transition between a first area and a second area in an operating environment, in particular a logistics facility, comprising:
a transition area, which separates the first area from the second area of the operating environment and which is limited on both sides in a width direction;
a monitoring device, which comprises at least two first sensor units located opposite one another with respect to the transition region and is set up to span in the transition region:
a substantially horizontally oriented monitoring field with a predetermined extent in a depth direction, which extends over the entire width of the transition region; and
at least one pair of entry fields, which extend in the depth direction with respect to the monitoring field and each have a predetermined extent in the width direction and the depth direction;
a control unit, which is operatively coupled to the monitoring device and is also set up for communication with vehicles moving in the operating environment;
wherein the control unit is further arranged to receive requests from the vehicles to pass through the transition area and to perform the following steps on receipt of such a request:
monitoring one of the pairs of entry fields with regard to an essentially simultaneous violation by a vehicle);
on detection of such a substantially simultaneous violation of the corresponding pair of entry fields, releasing a passage corridor through the monitoring field, the passage corridor having a predetermined width and lying in extension of the pair of entry fields; and
monitoring the passage of the vehicle through the passage corridor and deactivating the passage corridor if it is detected that the passage has been completed.

2. System according to claim 1,
wherein the control unit is further arranged to instruct activation of a pair of entry fields only after receipt of a request to pass through the transition area.

3. System according to claim 1,
wherein the control unit is further arranged to divide the passage corridor into a first passage section and a second passage section with respect to an intended direction of passage from the entry fields and to monitor that the first passage section is entered first and then the second passage section is entered, and/or
wherein a further pair of entry fields is located opposite each pair of entry fields in relation to the horizontal monitoring field and the control unit is furthermore set up to determine a direction of passage of a corresponding vehicle by means of the monitoring of the entry fields and the horizontal monitoring field.

4. System according to claim 1,
wherein the control unit is further arranged to start timing after receiving a request for a passage through the transition area and to deactivate the entry fields and/or the passage corridor after a predetermined maximum period of time and/or to monitor that a passage through the passage corridor requires at least a predetermined minimum period of time.

5. System according to claim 1,
wherein the control unit is furthermore set up to be able to release at least two passage corridors spaced apart in the width direction with entry fields assigned thereto.

6. System according to claim 1,
wherein the monitoring device further comprises at least one further sensor unit, which is arranged above the horizontal monitoring field.

7. System according to claim 6,
wherein the monitoring device is furthermore set up to span a further, essentially vertical monitoring field by means of the at least one further sensor unit, wherein the at least one passage corridor can and/or the monitoring device is furthermore set up to a narrow field within the at least one passage corridor, in particular by means of a horizontally aligned, very narrow monitoring field in the direction of travel or a light barrier extending transversely to the direction of travel.

8. System according to claim 4,
wherein the control unit is further arranged to determine the minimum time period and/or the maximum time period and/or the height and/or width of the drive-through corridor on the basis of at least one characteristic of the corresponding vehicle which has been received in the form of vehicle-specific information in connection with the request for a drive-through.

9. System according to claim 1,
wherein the control unit is further arranged to accept a request to pass through the transition area only if an instantaneous distance of the corresponding vehicle from the horizontal monitoring field is below a predetermined maximum distance, which is preferably 180 mm or less.

10. System according to claim 1,
wherein the control unit is furthermore set up to instruct the triggering of at least one predetermined safety measure, in particular the immobilization of devices and/or vehicles in the operating environment, in the event of unauthorized entry into the transition area.

11. A logistics device comprising an operating environment having a first area and a second area and a transition area arranged between the first area and the second area, further comprising a system for controlling a transition between the first area and the second area according to claim 1.

12. Logistics device according to claim 11,
wherein one of the first area and the second area serves as a safety area,
wherein devices located in the safety area are shut down in the event of unauthorized entry into the transition area.

13. A method for controlling a transition between a first area and a second area of an operating environment, in particular a logistics facility, by means of a system according claim 1, comprising:
Permanent monitoring of the horizontal and, if necessary, the vertical monitoring field and/or the narrow field; and
when receiving a request to pass through the transition area from a vehicle moving in the operating environment:
Monitoring of a pair of entry fields with regard to an essentially simultaneous violation by a vehicle;
if such a substantially simultaneous violation of the corresponding pair of entry fields is detected, releasing a passage corridor through the at least one monitoring field, the passage corridor having a predetermined width and possibly a predetermined height and lying in extension of the pair of entry fields; and
Monitoring the passage of the vehicle through the passage corridor and deactivating the passage corridor if it is detected that the passage has been completed.

14. Method according to claim 13, further comprising, in connection with receiving the request for passing through the transition area, receiving further vehicle-specific information, in particular a vehicle type and/or a vehicle identifier.

15. Method according to claim 14, further comprising adjusting the minimum time period and/or the maximum time period and/or the height of the drive-through corridor based on the vehicle-specific information.
